(19) United States
(12) Patent Application Publication
(10) Pub. No.: US 2006/0210335 A1
(43) Pub. Date: Sep. 21, 2006

(54) Hopper unit

(75) Inventors: Mitsuhiro Shikan, Kahoku-shi (JP); Takumi Nakayama, Kahoku-shi (JP)

Correspondence Address: STAAS & HALSEY LLP, SUITE 700, 1201 NEW YORK AVENUE, N.W., WASHINGTON, DC, 20005, US

(73) Assignee: PFU LIMITED, Ishikawa (JP)

(21) Appl. No.: 11/371,006

(22) Filed: Mar. 9, 2006

(30) Foreign Application Priority Data
Mar. 15, 2005 (JP) P2005-072315

(51) Int. Cl. G03G 15/00

(52) U.S. Cl. 399/377

(57) ABSTRACT

A paper abutment plate is provided for improving setting characteristics such as alignment of leading ends of papers when the papers are set on a tray. When the hopper unit is installed in a main body of an apparatus, the paper abutment plate is fixed to the main body of the apparatus. When the paper is fed to the main body of the apparatus in a state that the paper abutment plate is fixed to the main body of the apparatus, only the tray on which the paper stacked is able to be raised and lowered while leaving the paper abutment plate as it is.

### BACKGROUND OF THE INVENTION

The present invention relates to a hopper unit having a paper abutment plate for improving paper setting characteristics, so as to realize a hopper unit in which when it is installed in a main body apparatus, a paper abutment plate is fixed, and only a tray portion with paper stacked thereon is vertically raised and lowered.

A scanner apparatus is provided with a mechanism called a hopper unit as a mechanism for feeding document paper to a main body of the apparatus.

A hopper unit has a portion called a tray for stacking document paper thereon, and the hopper units include a bottom picking-out type in which the document paper stacked on this tray is fed starting with a lowermost sheet, as well as a top picking-out type in which the stacked document paper is fed starting with an uppermost sheet.

In a case where the paper is fed to the main body of the apparatus in the top picking-out type, it is necessary to raise the tray with the paper stacked thereon by a motor so that a fixed application pressure acts with respect to a feed roller irrespective of the number of sheets of the paper stacked on the tray. With a related hopper unit, however, a paper abutment plate is not provided, so that it has been necessary to set the paper after the hopper unit is installed in the main body of the apparatus.

For this reason, there has been a problem in that while the document paper is being subjected to read processing by the apparatus, a next document stack cannot be prepared on another hopper unit since the hopper unit is not provided with the paper abutment plate.

To overcome such a problem, a hopper unit is known in which a paper abutment plate is fixed on the tray (refer to JP-A-2001-253571).

With such a hopper unit, however, in the case where the paper is fed in the top picking-out type, a spring mechanism is required for pushing up the paper onto the tray portion so that the paper can pass over the paper abutment plate. Hence, there is a problem in that the application pressure acting with respect to the feed roller unfavorably changes depending on the number of paper sheets stacked on the tray portion.

In addition, there is another problem in that the abutment plate constitutes a hindrance when the hopper unit is rotated and accommodated in the main body of the apparatus.

As described above, the following problems are encountered in the related art.

Since the hopper unit is not provided with the paper abutment plate, there is a problem in that a next document stack cannot be prepared on another hopper unit while the document is being read.

To overcome such a problem, there is a device in which a paper abutment plate is fixed on the tray. With such a device, however, to ensure that the paper can pass over the paper abutment plate, a spring mechanism is required for pushing up the paper onto the tray. Hence, there is the problem that the application pressure acting with respect to the feed roller unfavorably changes depending on the number of the document sheets stacked on the tray portion.

In addition, there is the other problem that the abutment plate constitutes a hindrance when the hopper unit is rotated and accommodated in the main body of the apparatus.

### SUMMARY

It is therefore an object of the invention to provide a hopper unit in which the tray is provided with the paper abutment plate so that the document paper can be set even when the hopper unit is removed from the main body of the apparatus, and in which when the hopper unit is installed in the main body of the apparatus, the paper abutment plate is fixed to the main body of the apparatus, and only the tray is raised and lowered to feed the paper.

It is also object of the invention to provide a hopper unit in which it is possible to accommodate the hopper unit in the main body of the apparatus by rotating the hopper unit when the apparatus is not in use.

In order to achieve the object, according to the invention, there is provided a hopper unit comprising:

a tray; and

a paper abutment plate is provided for improving setting characteristics such as alignment of leading ends of papers when the papers are set on the tray, wherein

when the hopper unit is installed in a main body of an apparatus, the paper abutment plate is fixed to the main body of the apparatus, and

when the paper is fed to the main body of the apparatus in a state that the paper abutment plate is fixed to the main body of the apparatus, only the tray on which the paper stacked is able to be raised and lowered while leaving the paper abutment plate as it is.

When the hopper unit is removed from the main body of the apparatus, the paper abutment plate may be fixed at a position at which the paper abutment plate upwardly projects with respect to the tray.

When the hopper unit is installed in the apparatus, only the tray on which the paper stacked may be rotated while leaving the paper abutment plate as it is, so that the hopper unit may be able to be accommodated in the apparatus so as to be integral with a main body external cover of the apparatus.

In a state in which the hopper unit is accommodated integrally with the main body external cover of the apparatus, the tray may be raised to cancel a lock between the tray and the main body external cover of the apparatus, the hopper unit is automatically opened so as to be set in a usable state.

In order to achieve the object, according to the invention, there is provided a hopper unit, which is detachably installed in an apparatus and from which a paper is transported to the apparatus, the hopper unit comprising:

a tray, on which the paper is stacked;

a abutment plate, which an end of the paper is abutted against, wherein

when the hopper unit is installed in the apparatus, the abutment plate is fixed to the apparatus and the tray is vertically movable with respect to the abutment plate.

When the hopper unit is removed from the apparatus, the abutment plate may be arranged such as to upwardly project from the tray.

When the hopper unit is installed in the apparatus, the abutment plate may be fixed to the apparatus and the tray is rotatable with respect to the abutment plate.

The tray may be accommodated in the apparatus and be fixed to the apparatus by a lock member.

The tray may be upwardly moved, so that fixation between the tray and the apparatus may be canceled, the hopper unit may be opened.

### BRIEF DESCRIPTION OF THE DRAWINGS

FIG. 1 is a diagram illustrating an embodiment of the invention;

FIGS. 2A to 2C are diagrams explaining the operation of a hopper unit;

FIGS. 3A and 3B are diagrams explaining the operation of accommodating a tray.

### DETAIL DESCRIPTION OF PREFERRED EMBODIMENTS

In the invention, the following mode of carrying out the invention is adopted.

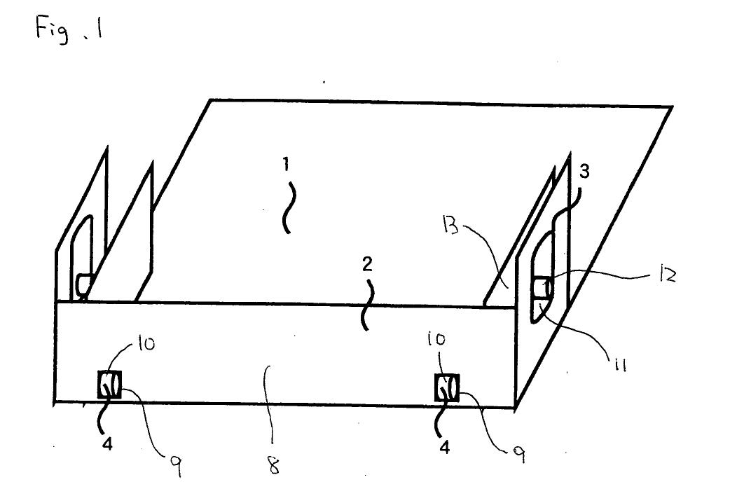

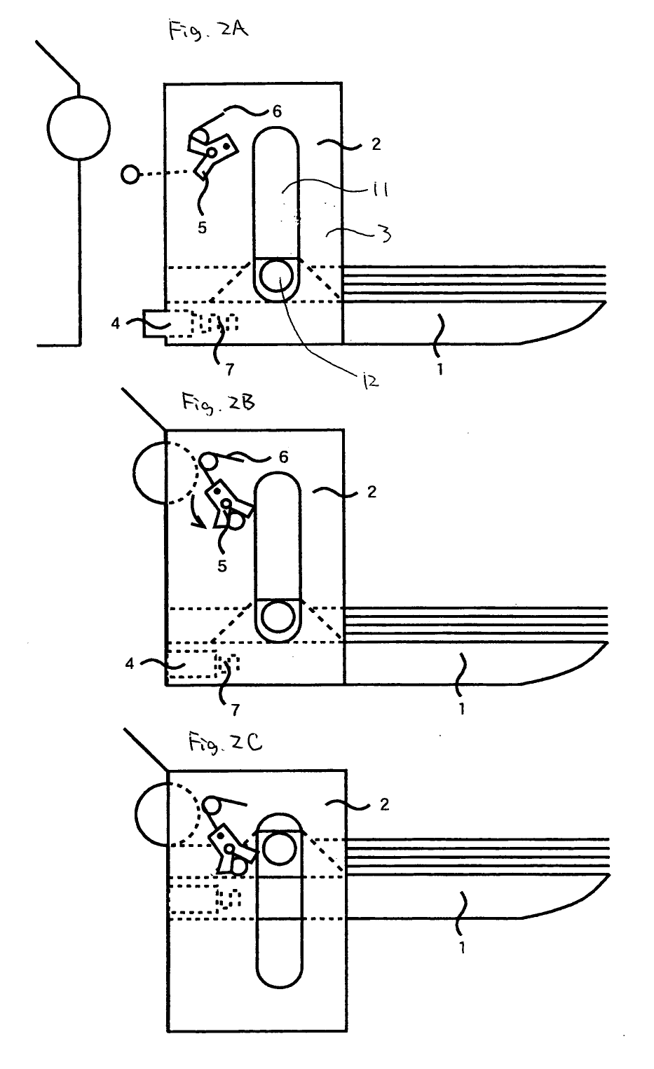

As shown in FIGS. 1 and 2, a paper abutment plate unit and a tray are arranged to be combined so that the tray is capable of being raised and lowered by a pair of vertical movement guide rails (guide members).

As a result, even when the hopper unit is removed from the main body of the apparatus, since the tray is provided with the paper abutment plate, it is possible to perform the setting of the paper on the tray.

At this time, the tray and the paper abutment plate are not fixed to each other, and the tray is adapted to be capable of being raised or lowered with respect to the paper abutment plate. It should be noted that in the state in which the hopper unit is removed from the main body of the apparatus, the paper abutment plate is adapted to be set in a state of upwardly projecting with respect to the tray by the force of a spring.

Further, even when the hopper unit is installed in the main body of the apparatus, the paper abutment plate is fixed, but the tray is capable of being raised and lowered along the vertical movement guide rails (guide members).

The paper abutment plate is detachably installed in the main body of the apparatus, and when it is installed, the paper abutment plate is fixed to the main body of the apparatus.

As a result, only the tray can be raised by a motor by means of a rack and pinion mechanism, and the document paper stacked on the tray can be brought into contact with a feed roller with a fixed application pressure, thereby making it possible to perform the feeding of the paper to the main body of the apparatus.

A pair of pins are respectively provided at distal ends of both side surfaces of the tray, and the arrangement provided is such that in a state in which the hopper unit is installed in the main body of the apparatus, the tray is rotated with respect to the paper abutment plate, and the pins are fixed by being fitted to latch locks of the main body of the apparatus, thereby allowing the hopper unit to be accommodated.

As a result, when the apparatus is not in use, the hopper unit can be accommodated in the main body of the apparatus.

Furthermore, the arrangement provided is such that when the apparatus is to be used, by raising the tray from this accommodated state, the pins at the distal ends of the side surfaces of the tray are disengaged from the latch locks, and the tray is rotated to return to the state in which the document paper can be stacked.

As a result, even if the user does not take the trouble to draw out the tray at the time of using the apparatus, the apparatus can be automatically set to a state capable feeding the paper.

### EMBODIMENT

Referring to the drawings, a description will be given of a representative embodiment of the invention. It should be noted that in the following description identical portions are denoted by the same reference numerals, and there are cases where a detailed description thereof is omitted.

FIG. 1 shows an embodiment of the invention.

In the drawing, a tray 1 is constructed so as to be capable of being raised and lowered by a paper abutment plate unit 2. The paper abutment plate unit 2 includes an abutment plate 8 and a pair of guide members (vertical movement guide rails) 3. The abutment plate 8 is formed with through holes 9 in which a pair of stopper/sliding rollers 4 are inserted respectively. Each of the guide members 3 is formed with a recess portion 11. A space receiving the stopper/sliding rollers 4 is arranged below a surface of the tray, which the papers are stuck on. The tray 1 includes a pair of side plate members 13 each of which a projection 12 being fitted to the recess portion 11 of the guide member 3 is provided on. The positions of the side plate members 13 are adaptable such that the sides of papers are abutted against the side plate members and are aligned.

FIGS. 2A to 2C show the operation of this hopper unit.

FIG. 2A shows a state in which the hopper unit is removed from the main body of the apparatus. In this state, the paper sheets on the tray 1 are set in a state capable of being fed with their leading ends aligned as the paper sheets are abutted against the abutment plate 8 of the paper abutment plate unit 2. At the same time, the stopper/sliding rollers 4 project from the abutment plate 8, so that the abutment plate 8 is fixed such as to stand on the tray 1.

FIG. 2B shows a state in which the hopper unit is installed in the main body of the apparatus. In this state, a lock lever 5 attached to the paper abutment plate unit 2 is locked by a pin provided on the main body of the apparatus by means of the force of a lock spring 6, and a compression spring 7 attached to each of the pair of stopper/sliding rollers 4 is compressed to cause the stopper/sliding roller 4 to be pushed toward the tray 1 side.

FIG. 2C shows a state in which the paper is being fed from the hopper unit to the main body of the apparatus. In a state in which the paper abutment plate unit 2 is fixed to the main body of the apparatus, only the tray 1 is raised, and the stacked paper is brought into contact with the feed roller so as to perform the feeding of the paper. At the same time, a roller 10 attached to each of the pair of stopper/sliding rollers 4 from the opposite side of the compression spring 7, is slid on the abutment plate 8.

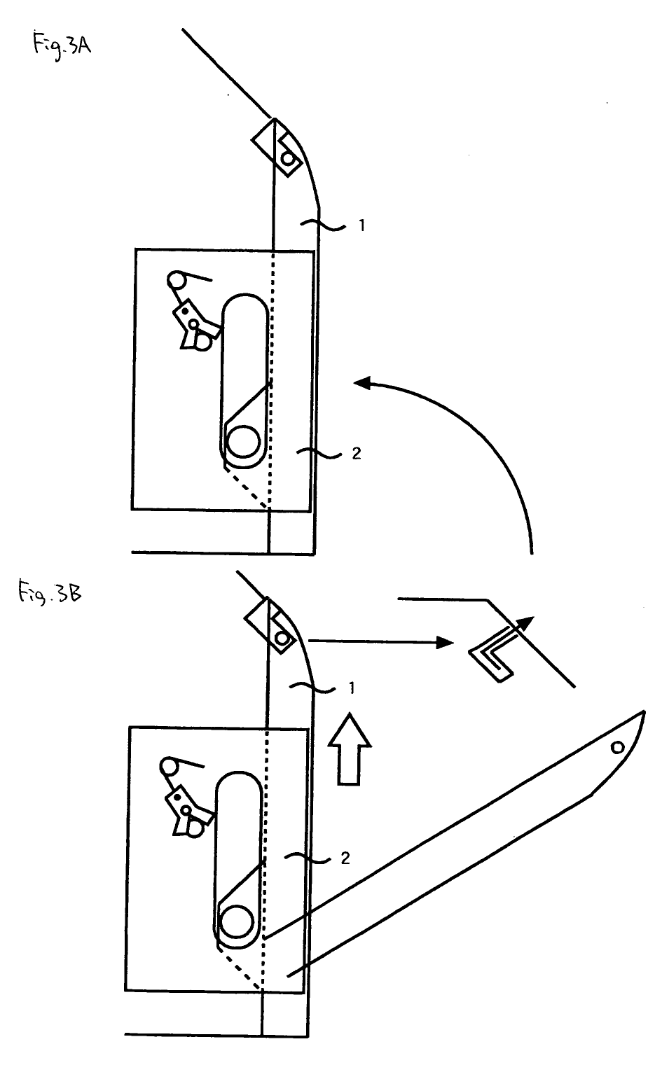

FIGS. 3A and 3B show the operation of accommodating the hopper unit.

FIG. 3A shows a state in which the hopper unit is installed in the main body of the apparatus. As the tray 1 is rotated with respect to the paper abutment plate unit 2, the tray 1 is arranged to be accommodated in the main body of the apparatus integrally with a main body cover.

In FIG. 3B, as the tray 1 is raised from its accommodated state at the time of using the apparatus, the pins provided at the distal ends of the side surfaces of the tray 1 are disengaged from the latch locks, so that the tray 1 can be rotated to return to the state capable of stacking the paper.

By virtue of the invention, it is possible to expect the following advantages.

While a document image is being read by the main body of the apparatus, it becomes possible to set a next document stack on another hopper unit.

In addition, by rotating the tray without interfering with the paper abutment plate, it becomes possible to accommodate the hopper unit in the main body of the apparatus.

What is claimed is:

1. A hopper unit comprising:
a tray; and
a paper abutment plate is provided for improving setting characteristics such as alignment of leading ends of papers when the papers are set on the tray, wherein
when the hopper unit is installed in a main body of an apparatus, the paper abutment plate is fixed to the main body of the apparatus, and
when the paper is fed to the main body of the apparatus in a state that the paper abutment plate is fixed to the main body of the apparatus, only the tray on which the paper stacked is able to be raised and lowered while leaving the paper abutment plate as it is.

2. The hopper unit according to claim 1, wherein
when the hopper unit is removed from the main body of the apparatus, the paper abutment plate is fixed at a position at which the paper abutment plate upwardly projects with respect to the tray.

3. The hopper unit according to claim 1, wherein
when the hopper unit is installed in the apparatus, only the tray on which the paper stacked is rotated while leaving the paper abutment plate as it is, so that the hopper unit is able to be accommodated in the apparatus so as to be integral with a main body external cover of the apparatus.

4. The hopper unit according to claim 3, wherein
in a state in which the hopper unit is accommodated integrally with the main body external cover of the apparatus, the tray is raised to cancel a lock between the tray and the main body external cover of the apparatus, the hopper unit is automatically opened so as to be set in a usable state.

5. A hopper unit, which is detachably installed in an apparatus and from which a paper is transported to the apparatus, the hopper unit comprising:
a tray, on which the paper is stacked;
a abutment plate, which an end of the paper is abutted against, wherein
when the hopper unit is installed in the apparatus, the abutment plate is fixed to the apparatus and the tray is vertically movable with respect to the abutment plate.

6. The hopper unit according to claim 5, wherein
when the hopper unit is removed from the apparatus, the abutment plate is arranged such as to upwardly project from the tray.

7. The hopper unit according to claim 5, wherein
when the hopper unit is installed in the apparatus, the abutment plate is fixed to the apparatus and the tray is rotatable with respect to the abutment plate.

8. The hopper unit according to claim 7, wherein
the tray is accommodated in the apparatus and is fixed to the apparatus by a lock member.

9. The hopper unit according to claim 8, wherein
the tray is upwardly moved, so that fixation between the tray and the apparatus is canceled, the hopper unit is opened.
